(19) United States
(12) Patent Application Publication
(10) Pub. No.: US 2013/0279512 A1
(43) Pub. Date: Oct. 24, 2013

(54) PROFRAMMABLE WIRELESS INTEGRATED TRANSCEIVER LIGHT HOUSING ENCLOSURE

(71) Applicants: Terence Fung, San Francisco, CA (US); David Leung, Millbrae, CA (US)

(72) Inventors: Terence Fung, San Francisco, CA (US); David Leung, Millbrae, CA (US)

(73) Assignee: One Touch Mediaroom, LLC, San Francisco, CA (US)

(21) Appl. No.: 13/451,105

(22) Filed: Apr. 19, 2012

(51) Int. Cl. H04L 12/28; F21V 21/00; E04B 1/35

(52) U.S. Cl. 370/406; 52/741.1; 362/362; 362/364

(57) ABSTRACT

A lighting housing for installation in a building having a source of electrical power, including a support structure; a junction box coupled to the support structure and to the source of electrical power; a lighting enclosure coupled to the support structure and mechanically and electrically supporting an electric light powered from the source of electrical power received through the junction box; and an RF mesh network transceiver, coupled to the support structure and powered from the junction box, for participation in a mesh network.

### BACKGROUND OF THE INVENTION

The present invention relates generally to networks, and more particularly but not exclusively, to efficient construction of wireless mesh network infrastructure.

Building automation generally refers to advanced functionality enabled for a control system used in a building. A building automation system represents a type of control system. This particular type of control system includes a computerized intelligent network of electronic devices designed to monitor and control various systems in a building (a building automation network).

Building automation systems interface with building infrastructure to provide monitoring, command, and control functions. These functions reduce building energy and maintenance costs when compared to non-controlled buildings, among other advantages.

Building automation networks historically have included a primary bus and a secondary bus which connect high level controllers (e.g., more complex or feature rich controller) with lower level controllers (e.g., simple, limited feature controller), I/O devices, and a user interface. The primary and secondary buses can include a single or a multi-bus implementation of optical fiber, twisted pair, Ethernet, and/or radiofrequency (RF) architectures. A large percentage of controllers are proprietary with each automation controls company providing controllers for specific applications. Some controllers provide limited control and others provide flexible control. These controllers operate with software that is also often proprietary while being interoperable with various open protocols like BACnet or LonTalk.

Newer building automation and lighting control solutions may use open and/or non-proprietary wireless mesh network standards such as ZigBee® that can provide interoperability and allow a user to employ devices from different manufacturers and provide integration with other compatible building control systems. The controllers and components of these networks are typically added as-needed to provide the particular type of control coverage. These components are typically stand-alone devices that are installed specifically for the application and require resources (e.g., time and materials) including provision of a separate source of power for each device.

Traditional control systems rely on a wired infrastructure that can include proprietary cabling systems. This characteristic is implicated in two instances where a user contemplates implementing a building automation system—new construction and retrofit construction to upgrade an existing building. In both cases, the traditional model identifies a specific wiring plan that contemplates a network using a set of controllers, most or all of which can be proprietary. This traditional model narrows implementation and scope of control to the economics, viability of wire installation, and availability of additional space to install new devices with supporting equipment.

For example, to install motion sensors for occupancy sensing that will turn off lights when a room is not being used, an automation network must be designed and built that provides sufficient coverage for those sensors. There is a cost to purchase, install, and hardwire routers to provide that coverage. Depending upon many parameters, it can be cost prohibitive to enable that particular installation which means the user foregoes the advantages attendant to the application. Particularly for many retrofit installations as cable installation often includes installing new cabling (typically some combination of signal cabling and power wires) which in turn requires cutting into walls and ceilings (which then requires post-installation repair). An installation that relies on connecting devices “wirelessly” still requires installation of power wiring and connectors to enable desired coverage as the “wireless” feature simply replaces the signal cabling component.

What is needed is an apparatus and method for improving the scalability, availability, viability, and economics of building automation mesh networks.

### BRIEF SUMMARY OF THE INVENTION

Disclosed is an apparatus and method improving the scalability, availability, viability, and economics of building automation mesh networks. The present invention includes embodiments directed towards simple and economical installation of mesh networks for wireless control infrastructure, both during new construction and retrofit construction.

A lighting housing for installation in a building having a source of electrical power, including a support structure; a junction box coupled to the support structure and to the source of electrical power; a lighting enclosure coupled to the support structure and mechanically and electrically supporting an electric light powered from the source of electrical power received through the junction box; and an RF mesh network transceiver, coupled to the support structure and powered from the junction box, for participation in a mesh network.

A mesh network for a building automation network having a source of electrical power including a plurality of lighting housings, each lighting housing installed in the building and including a support structure; a junction box coupled to the support structure and to the source of electrical power; a lighting enclosure coupled to the support structure and mechanically and electrically supporting an electric light powered from the source of electrical power received through the junction box; and an RF mesh network transceiver, coupled to the support structure and powered from the junction box, for participation in a mesh network; a mesh transmitter transmitting a message to a first one RF mesh network transceiver; and a mesh receiver receiving the message from a second one RF mesh network transceiver coupled to the one RF mesh network transceiver through one or more other RF mesh network transceivers.

A method for constructing a mesh network for a building automation network having a source of electrical power, including a) installing a plurality of lighting housings in the building, each lighting housing having an electric light powered by the source of electrical power received through a junction box, and each lighting housing including an integrated RF mesh network transceiver; b) powering each the integrated RF mesh network transceiver through the junction box to provide a plurality of powered RF mesh network transceivers; and c) forming the mesh network from the plurality of powered RF mesh network transceivers.

Features/benefits include an ability to simply, economically, and automatically (concurrent with installation of enhanced lighting housings into a building) provide a wireless control infrastructure compatible with any controller, control system, and controlled device. Budgeting for planning and installation of the RF mesh network installation are reduced or no longer required. Other features, benefits, and advantages of the present invention will be apparent upon a review of the present disclosure, including the specification, drawings, and claims.

### BRIEF DESCRIPTION OF THE DRAWINGS

The accompanying figures, in which like reference numerals refer to identical or functionally-similar elements throughout the separate views and which are incorporated in and form a part of the specification, further illustrate the present invention and, together with the detailed description of the invention, serve to explain the principles of the present invention.

FIG. 1 illustrates a top perspective view of an improved mesh network router light housing;

FIG. 2 illustrates a bottom perspective of the housing of FIG. 1;

FIG. 3 illustrates a general block diagram of a schematic for the housing of FIG. 1;

FIG. 4 illustrates a network mesh enabled by use of multiple ones of the housing of FIG. 1;

FIG. 5 illustrates a top perspective view of an alternate improved mesh network router light housing; and

FIG. 6 illustrates a bottom perspective of the housing of FIG. 5.

### DETAILED DESCRIPTION OF THE INVENTION

Embodiments of the present invention provide an apparatus and method improving the scalability, availability, viability, and economics of building automation mesh networks. The following description is presented to enable one of ordinary skill in the art to make and use the invention and is provided in the context of a patent application and its requirements.

For any user interested in building automation, whether residential, commercial, or large industrial scale, whether new construction or retrofit, one motivation is energy saving. Another motivation is enhanced functionality available from use of mesh networked control systems and controlled devices. One typical application of building control systems includes automation of building lighting systems which includes selection and installation of new lighting systems using multiple recessed ceiling light housings distributed throughout the building. Integration of an RF mesh network router into every installed light housing provides low-cost solutions to the problems of the prior art. Provision of this novel integration is a deceptively simple combination that belies its power and value. Each light housing installed extends the reach of the RF mesh network with virtually no additional cost. Because the RF mesh network router is integrated into each lighting housing that is powered, the RF mesh network router is automatically powered without installation of additional power lines specifically for the router. These housings thus do not require extra wiring or circuitry and extends the RF mesh network throughout the installation wherever lighting is installed. A further advantage of this combination is that the light housings are installed into the ceiling or other elevated areas which provide an optimum location for RF mesh routers. Secondarily each lighting system within the integrated light housing may be easily controlled through a controller coupled into the RF mesh network enabled through this integration.

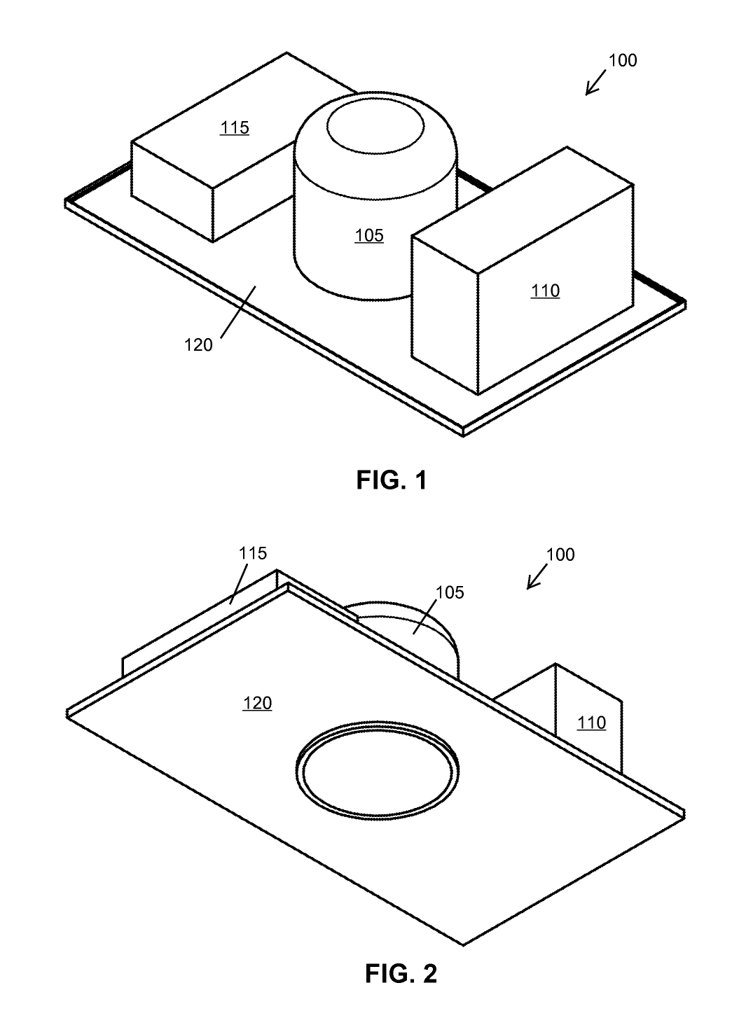

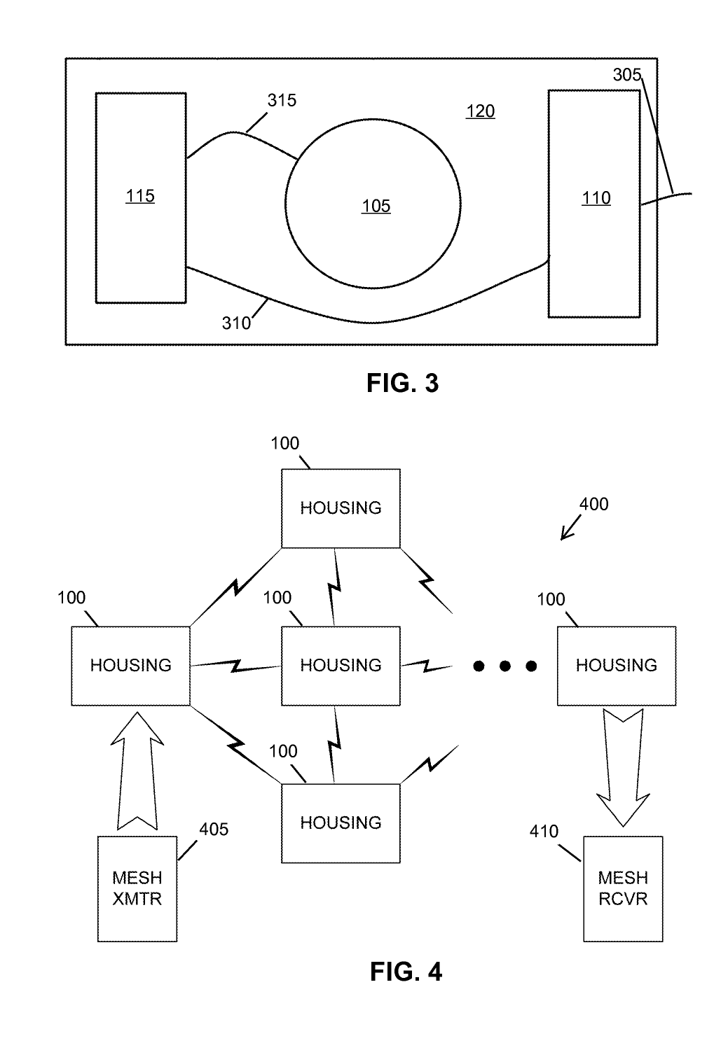

FIG. 1 illustrates a top perspective view of an improved mesh network router light housing 100, FIG. 2 illustrates a bottom perspective of housing 100, and FIG. 3 illustrates a general block diagram of a schematic for housing 100. Housing 100 includes a lighting enclosure 105, a junction box 110, and a radiofrequency (RF) mesh network module 115 all coupled to a top of a recessed support structure 120. Lighting enclosure 105 is a receptacle for mechanically and electrically interfacing to an electric light (e.g., incandescent light bulb, fluorescent lamp, compact fluorescent lamp (CFL), cold cathode fluorescent lamps (CCFL), high-intensity discharge lamp, light-emitting diodes (LEDs), and the like). Because of the wide variety of supported electric lights, the term “lighting housing” is broad to include virtually any type of light and is not limited to support of “bulb” type lights. While housing 100 may require some adaptation for any particular type of electric light, the particular type of supported electric light is not a primary feature.

Junction box 110 receives lighting power and is typically AC main connected into a main power supply of the installation site. This source of power is not limited to the power grid as other power sources may be used in conjunction with housing 100, such as battery or local generator power. This is a feature of some embodiments of the present invention, as long as the lights are powered, the RF mesh network infrastructure is available. This is useful in case of certain types of emergency conditions when backup power is available to the lighting system to re-enable some building automation features for use during the emergency condition.

Junction box 110 may provide a simple electro-mechanical interface or it may include power processing devices (e.g., transformers, rectifiers, and the like) to process lighting power. Junction box 110 thus provides (directly or indirectly) necessary power to both lighting enclosure 105 and RF mesh network transceiver 115. For example, in FIG. 3, junction box 110 receives AC mains power from the building power source at an electrical interface 305. A high voltage connection 310 couples junction box 110 to RF mesh network transceiver 115 and a low voltage connection 315 couples RF mesh network transceiver 115 to lighting enclosure 105.

RF mesh network transceiver 115 enables, in cooperation with all other installed housings 100, formation and operation of a wireless mesh network. Each housing 100 a wireless mesh node that in cooperation with other housings 100 automatically establish a mesh network of connectivity throughout the building. One or more particular protocols may be implemented by RF mesh network transceiver 115 dependent upon implementation and design requirements. RF mesh network transceiver 115 implements a low data-rate wireless personal area network mesh, preferably conforming to IEEE 802.15.4, such as ZigBee, ISA100.11a, WirelessHART, MiWi, 6LoWPAN, Bluetooth®, standard Internet protocols, and the like. RF mesh network transceiver 115 provides a physical layer and media access control throughout the installation preferably using a low-power digital radio. RF mesh network transceiver 115 conforms to IEEE Std 802.15.4d™-2009 (Amendment to IEEE Std 802.15.4™-2006) both of which are hereby expressly incorporated in their entireties by reference thereto for all purposes.

While RF mesh network transceiver 115 may implement and support multiple types of protocols, ZigBee offers a suite of high level communications protocols that includes secure mesh networking for wireless communication and control of many types of devices and equipment including wireless light switches, electrical meters with displays, and other consumer and industrial equipment that operate using wireless low rate data transfers. The following list is representative without being exhaustive: home entertainment and control—home automation, smart lighting, advanced temperature control, safety and security, movies and music; wireless sensor networks—including individual sensors like Telosb/Tmote and Iris from Memsic and the like; industrial control (control systems used in industrial production—SCADA, DCS, PLC and the like); embedded sensing; medical data collection; smoke and intruder warning; and building automation. The current ZigBee specification, officially ZigBee 2007, is available from the ZigBee Alliance, 2400 Camino Ramon, Suite 375, San Ramon, Calif. 94583, USA (zigbee.org) and is hereby expressly incorporated in its entirety by reference thereto for both ZigBee and ZigBee PRO feature sets.

In an installation conforming to the ZigBee specification, there are three types of devices: a coordinator, a router, and an end device. RF mesh network transceiver 115 would perform the router function to pass on data from other devices. As allowed by the ZigBee specification, RF mesh network transceiver 115 may, secondarily, run an application function when operating as a router. This application function would, when enabled, provide for control of the electric light disposed within lighting enclosure 105.

Support structure 120 is a mechanical structure supporting lighting enclosure 105, junction box 110, and RF mesh network transceiver 115. While not necessarily required to be recessed, many typical modern ceiling installations include recessed housings. Support structure 120 may be implemented into virtually any design and form factor. Some types of electric lights have special housing requirements for lighting enclosure 105, junction box 110, and support structure 120 (e.g., fluorescent lighting with ballast and elongated tray) and support structure 120 is configured to properly support the specific application.

FIG. 4 illustrates a network mesh 400 enabled by use of multiple interconnected housings 100 to produce a whole building wireless mesh network coverage. Network mesh 400 provides low-management intelligent control throughout the installation, with an area of reach automatically extended by each additional housing 100. Network mesh 400 includes, in addition to the plurality of housings 100, a mesh transmitter 405 initiating a message transmission and a mesh receiver 410 receiving the message transmission through multiple interconnected ones of housing 100. Of course one or both of mesh transmitter 405 and mesh receiver 410 may be transceivers for both receiving and transmitting messages as needed.

Particular implementations will have the general arrangement illustrated in FIG. 4 with some variation as necessary/desirable. With network mesh 400 conforming to the ZigBee specification for example, mesh transmitter 405 may serve as the ZigBee coordinator, housings 100 as the ZigBee router, and mesh receiver 410 as a ZigBee End Device (which in turn may be a particular electric light in a remote housing 100).

All the benefits of RF mesh networks are available to network mesh 400, the specifics based upon whether implemented using a flooding technique or a routing technique, including ad hoc formation, self-healing, automatic configuration and dynamic reconfiguration, and the like.

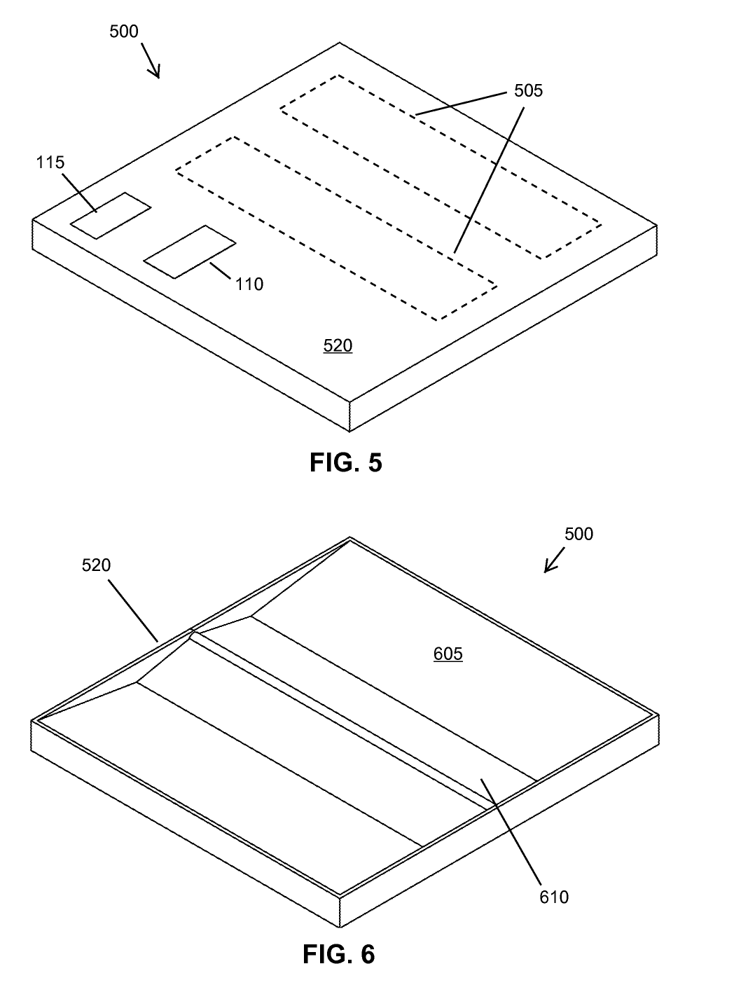

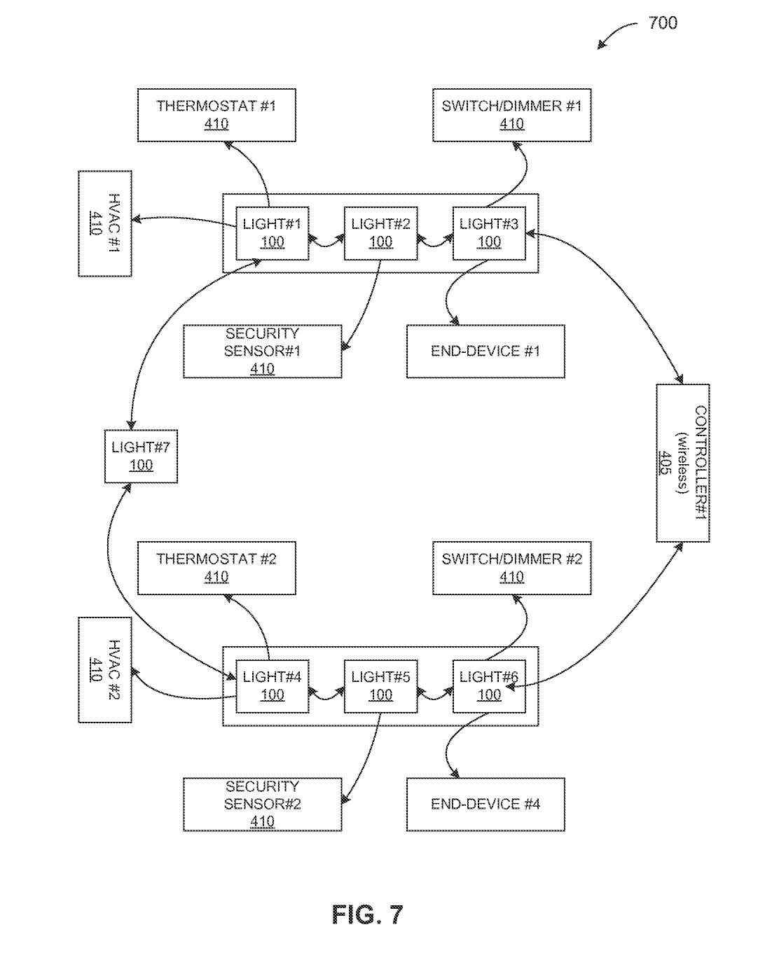

FIG. 5 illustrates a top perspective view of an alternate improved mesh network router light housing 500, and FIG. 6 illustrates a bottom perspective of housing 500. Housing 500 generally conforms to housing 100 adapted for a fluorescent light. In general outside the specifics of the electrical and mechanical interface changes, housing 500 may be substituted for housing 100 in the discussion herein, and is compatible with formation of network mesh 400 and is able to participate as a mesh network node along with housing 100 in network mesh 400. A general block diagram of a schematic for housing 500 generally conforms to the schematic shown in FIG. 3. Housing 500 includes a lighting enclosure 505, junction box 110, and RF mesh network transceiver 115 all coupled to a top of a recessed support structure 520. Housing 500 includes a fluorescent reflector 605 and a diffuser panel 610.

Various modifications to the preferred embodiment and the generic principles and features described herein will be readily apparent to those skilled in the art. In some embodiments, it may be necessary or desirable to add additional network or communications functionality. For example, a secondary aspect includes addition of WiFi networking capability interfaced to housing 100 or part of network mesh 400 to add more traditional monitoring, command, and control functions. Further, the disclosed embodiment include a reference to junction box 110. This broadly represents the mechanical and electrical interface functions of the lighting housing and typically includes an integration of both an electrical junction box and power conditioning components (e.g., transformer and the like). In some implementations, these functions may be explicitly separated. The electrical junction box provides the physical electrical interconnection with a building power source and the power conditioning components converting energy from the building power source to a format suitable for use by the electrical housing. While some preferred embodiments include use of a particular ZigBee specification, the present invention is not limited to this particular specification or to any past, present, or future specification of ZigBee as other mesh protocols may be used in the present invention. Thus, the present invention is not intended to be limited to the embodiment shown but is to be accorded the widest scope consistent with the principles and features described herein.

The systems and methods are preferably implemented using a microprocessor executing program instructions from a memory, the instructions causing the apparatus to perform as described herein. The system and methods above has been described in general terms as an aid to understanding details of preferred embodiments of the present invention. In the description herein, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

Reference throughout this specification to “one embodiment”, “an embodiment”, or “a specific embodiment” means that a particular feature, structure, or characteristic described in connection with the embodiment is included in at least one embodiment of the present invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims. Thus, the scope of the invention is to be determined solely by the appended claims.

What is claimed as new and desired to be protected by Letters Patent of the United States is:

1. A lighting housing for installation in a building having a source of electrical power, comprising:
a support structure;
a junction box coupled to said support structure and to the source of electrical power;
a lighting enclosure coupled to said support structure and mechanically and electrically supporting an electric light powered from the source of electrical power received through said junction box; and
an RF mesh network transceiver, coupled to said support structure and powered from said junction box, for participation in a mesh network.

2. The lighting housing of claim 1 wherein said support structure is configured for recessed installation within the building and wherein said lighting enclosure is recessed within said support structure.

3. The lighting housing of claim 1 wherein said RF mesh network transceiver provides low voltage operating power to said lighting enclosure.

4. The lighting housing of claim 1 wherein said RF mesh network transceiver includes a mesh router for participation in said mesh network.

5. The lighting housing of claim 2 wherein said RF mesh network transceiver includes a mesh router for participation in said mesh network.

6. The lighting housing of claim 5 wherein said mesh router is compliant with a ZigBee 2007 specification.

7. The lighting housing of claim 4 wherein said RF mesh network transceiver includes an application for controlling said electric light supported by said lighting enclosure.

8. The lighting housing of claim 6 wherein said RF mesh network transceiver includes an application for controlling said electric light supported by said lighting enclosure.

9. A mesh network for a building having a source of electrical power, comprising:
a plurality of lighting housings, each lighting housing installed in the building and including a support structure; a junction box coupled to said support structure and to the source of electrical power; a lighting enclosure coupled to said support structure and mechanically and electrically supporting an electric light powered from the source of electrical power received through said junction box; and an RF mesh network transceiver, coupled to said support structure and powered from said junction box, for participation in a mesh network;
a mesh transmitter transmitting a message to a first one RF mesh network transceiver; and
a mesh receiver receiving said message from a second one RF mesh network transceiver coupled to said one RF mesh network transceiver through one or more other RF mesh network transceivers.

10. A method for constructing a mesh network for a building having a source of electrical power, said method comprising the steps of:
a) installing a plurality of lighting housings in the building, each lighting housing having an electric light powered by the source of electrical power received through a junction box, and each lighting housing including an integrated RF mesh network transceiver;
b) powering each said integrated RF mesh network transceiver through said junction box to provide a plurality of powered RF mesh network transceivers; and
c) forming the mesh network from said plurality of powered RF mesh network transceivers.

11. The mesh network constructing method of claim 10 wherein said support structure is configured for recessed installation within the building and wherein said lighting enclosure is recessed within said support structure.

12. The mesh network constructing method of claim 10 includes providing low voltage operating power to said lighting enclosure using said RF mesh network transceiver.

13. The mesh network constructing method of claim 10 wherein said RF mesh network transceiver includes a mesh router for participation in said mesh network.

14. The mesh network constructing method of claim 11 wherein said RF mesh network transceiver includes a mesh router for participation in said mesh network.

15. The mesh network constructing method of claim 14 wherein said mesh router is compliant with a ZigBee 2007 specification.

16. The mesh network constructing method of claim 13 further comprising controlling said electric light supported by said lighting enclosure using said RF mesh network transceiver.

17. The mesh network constructing method of claim 15 wherein said RF mesh network transceiver includes an application for controlling said electric light supported by said lighting enclosure.
